(19) United States
(12) Patent Application Publication
(10) Pub. No.: US 2003/0026637 A1
(43) Pub. Date: Feb. 6, 2003

(54) Keyboard/keypad device and computer featuring the same

(76) Inventor: Yuanzong Fu, Salt Lake City, UT (US)

Correspondence Address: Steve M. Perry, THORPE, NORTH & WESTERN, L.L.P., P.O. Box 1219, Sandy, UT, 84091-1219, US

(21) Appl. No.: 10/208,137

(22) Filed: Jul. 29, 2002

Related U.S. Application Data
(60) Provisional application No. 60/309,371, filed on Aug. 1, 2001.

(51) Int. Cl. B41J 5/08

(52) U.S. Cl. 400/472

(57) ABSTRACT

A keyboard device is provided for use with a computing device. The keyboard device includes a plurality of keys arranged on the keyboard, and each key corresponds to a letter in an alphabet. At least three rows are included in the keyboard in which the keys are arranged on the keyboard, and each row includes a set of letters arranged in the row in a sequential order. The sequential arrangement of the keys on the keyboard assists a user of the keyboard in recalling a location of any particular key corresponding to a particular letter of the alphabet, and enables the user to more quickly enter keystroke commands to the computing device.

This application claims benefit of U.S. Provisional Patent Application Serial No. 60/309,371 filed Aug. 1, 2001.

### FIELD OF THE INVENTION

The present invention is a keyboard and keypad system for use with computers or controlling electronic devices, as well as a computer with the above feature.

### BACKGROUND

Currently, a popular form of keyboards and keypads used to control computers and other electronic devices is the QWERTY arrangement. The QWERTY key arrangement system was invented over 100 years ago and it is not easy to operate nor is it convenient to use. Furthermore, the speed of typing when using the QWERTY system is relatively slow because the inventor designed it for use with mechanical typewriters. Because typing too rapidly with a mechanical typewriter could result in wrinkling the paper or causing the striking elements to jam, the QWERTY system was designed to regulate the speed of typing. The designer of the QWERTY arrangement intentionally designed it to be irregular and inconsistent, forcing the typist's speed to slow down. Thereby, the mechanism of the typewriter could keep up with the typist, and the paper would not get crumpled. The QWERTY arrangement was also used to reduce the possibility of multiple letters being typed in one spot on the documents which are being typed. Typewriters provide script that is clearer and easier to read in a document as opposed to using handwriting. However, the QWERTY design does not emphasize the user's speed and convenience as much as it emphasizes a solution to overcome typewriter jamming.

The act of typing information into a keyboard or computer is an action and behavior of the brain, arm, and hand, as well as coordination of the entire body. The QWERTY keyboard has the following design problems because it is designed as an inconsistent and inconvenient arrangement:

A. Because the letters are not regularly and logically arranged, it is difficult for the user to memorize the positions of the letters. In other words, this kind of keyboard design intentionally causes a resulting brain and muscle confusion or “brain stump.”

B. The QWERTY keyboard design is not suitable for the human brain's organization or for the orderly coordination of the brain with the hand, arm, and the rest of the body. Therefore, this kind of keyboard design intentionally causes “hand and/or finger stump.”

C. Because of the brain and muscle confusion or “brain and hand/finger stump,” people who use the QWERTY keyboard cannot achieve optimal results because the brain cannot cooperate systematically with the hand.

Because of the above deficiencies of the QWERTY design, it is difficult for the users to learn and to operate. This is especially true for those users of the QWERTY keyboard design whose native language is not English. Not only must non-native English speakers overcome the difficulty of translating the native language with which they are accustomed to speaking into English, they must then overcome the muscle and hand confusion of the QWERTY keyboard. The typing speed and data entry of non-native speakers cannot be improved above a certain level because of the design deficiencies described. In other words, for most of the people in the world, increasing the speed of typing on the old keyboard is extremely difficult. For this reason, many non-native English speakers cannot meet the basic speed of typing requirements for many jobs, and can lose many job opportunities.

Presently, computers are used nearly all over the world in every field and in many families. Even outside the U.S., computer users are compelled to use the QWERTY keyboard because it has become the de facto worldwide standard. It is believed that a computer does not limit the typing speed of a typist. Accordingly, the speed of typing and data entry should not be limited as it was formerly limited for mechanical typewriters. In contrast, users and typists want to be able to execute keystrokes as quickly as possible.

Currently, all over the world, whether it is in an English-speaking area or in an English as a second-language area, nearly everyone uses a QWERTY keyboard. As an example, in the United States, courses for teaching typing and speed typing are taught in elementary schools, high schools, technical schools, and even in colleges and universities. The cost and effort spent on speed-type training are too high to be estimated. Since a large majority of people cannot meet minimum typing requirements, the results for these members of society are many lost job opportunities. In another respect, employers that cannot find efficient typists may spend money to hire extra people to accomplish their data entry needs. However, because of the disadvantages of the QWERTY keyboard design, typing speeds still have great limitations. The design and arrangement of the QWERTY keyboard cannot meet the needs of current computers and electronic data entry devices in all fields. At least it cannot achieve optimal results.

### SUMMARY OF THE INVENTION

A keyboard device is provided for use with a computing device. The keyboard device includes a plurality of keys arranged on the keyboard, and each key corresponds to a letter in the alphabet. At least three rows are included in the keyboard in which the keys are arranged on the keyboard, and each row includes a set of letters arranged in the row in a sequential order. The sequential arrangement of the keys on the keyboard assists a user of the keyboard in recalling a location of any particular key corresponding to a particular letter of the alphabet, and enables the user to more quickly enter keystroke commands to the computing device.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a keyboard with the keys organized sequentially from left-to-right in accordance with an embodiment of the present invention;

FIG. 2 illustrates a keyboard with the keys organized sequentially from left-to-right;

FIG. 3 illustrates a keyboard with the keys organized sequentially from left-to-right and;

FIG. 4 illustrates a keyboard with the keys organized sequentially from bottom-to-top in a left-to-right order;

FIG. 5 illustrates a split keyboard with an ergonomic configuration and hot function keys, with the keys organized sequentially from in a left-to-right order;

FIG. 6 illustrates a split keyboard with an ergonomic configuration with the keys organized sequentially from left-to-right;

FIG. 7 illustrates a split keyboard with an ergonomic configuration with the keys organized sequentially from left-to-right and then from bottom-to-top;

FIG. 8 illustrates a keyboard with the keys organized sequentially from left-to-right, which can be used as a component of an industrial control system;

FIG. 9 illustrates a foldable keyboard with the keys organized sequentially from left-to-right;

FIG. 10 illustrates a split keyboard wherein each side can be spatially distanced from the other, with the keys organized sequentially from left-to-right;

FIG. 11 illustrates a keyboard for use with a portable computing device; and

FIG. 12 illustrates a slidably expandable keyboard for use with a computing device.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

In order to overcome the disadvantages of the QWERTY arrangement, this invention provides a fast, accurate, and easily used computer keyboard/keypad and control device for data and information input as well as typing. This invention provides a better fit for a user's orderly brain, hand, and body coordination. This present invention can increase the speed and accuracy of the user's data and information input and typing. This invention can be used with a computer or other electronic processing equipment.

In order to overcome the problems described above, this invention provides a computing device with a unique information or data input and typing device or keyboard/keypad. The keyboard includes at least 26 letters that are arranged in a sequential arrangement. This sequential arrangement is valuable because when individuals learn the English language they learn the order of the alphabet sequentially. Thus, their brain is “pre-wired” for a sequential configuration. The keyboard uses the 26 letters of the alphabet sequentially arranged from A through Z.

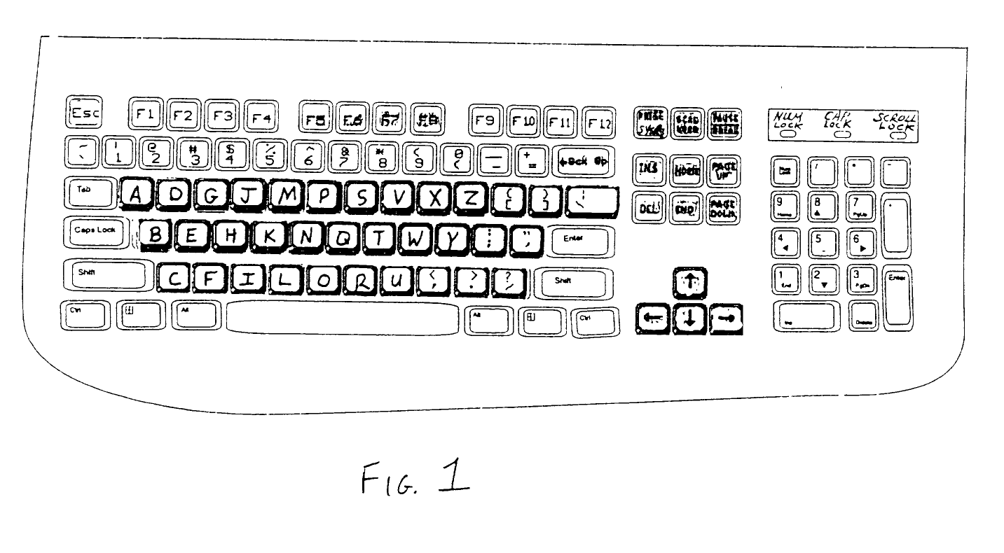

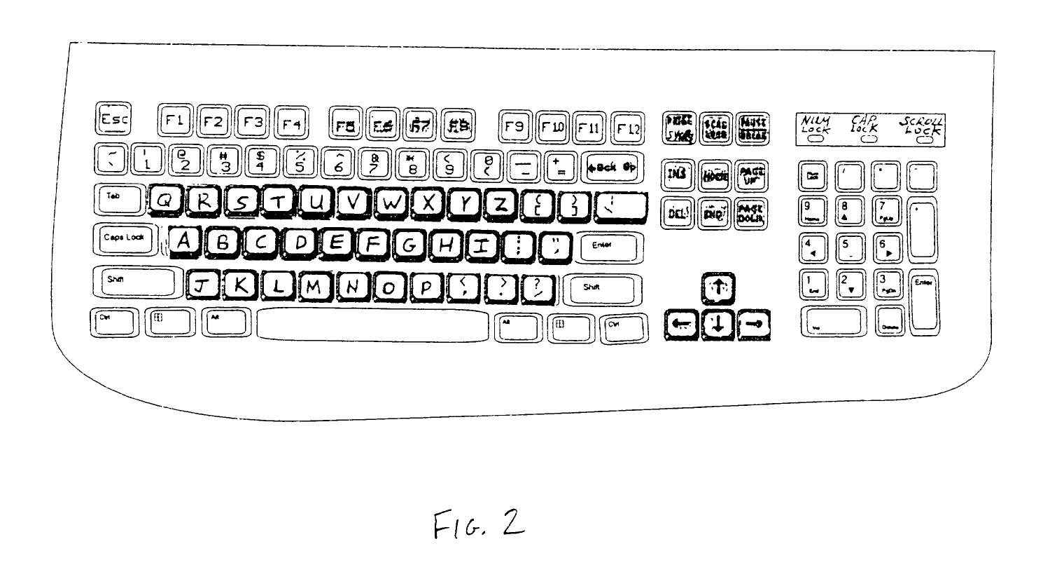

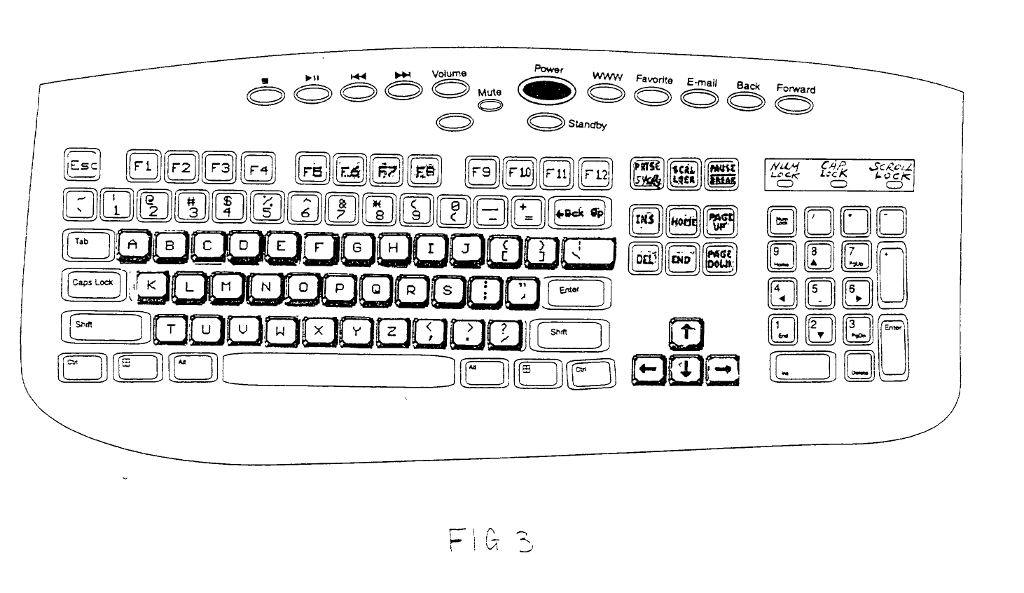

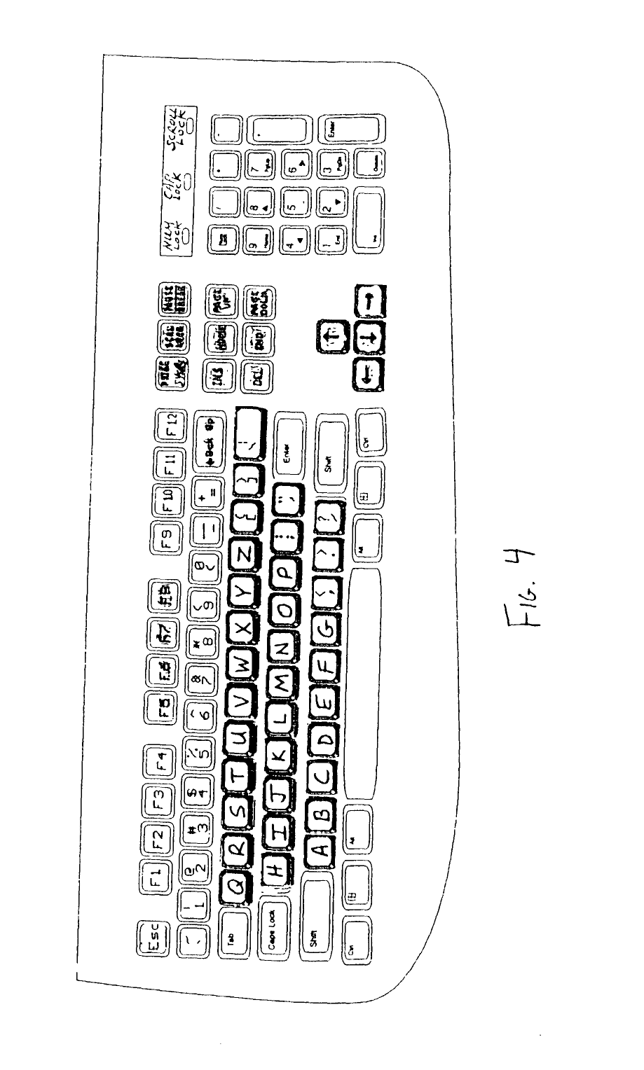

According to this invention, the 26 letters can be arranged from top-to-bottom in several different rows. For example, as shown in FIG. 1, there can be three rows on the keyboard. In this embodiment, the keys are arranged in sequential order from top-to-bottom and then left-to-right order, beginning with the letter A on the leftmost and uppermost corner. Other arrangements are possible as well. For instance, the keys can be arranged in sequential order on any given row, yet ordered differently from top-to-bottom. As shown in FIG. 2, the middle, or “home” row can contain the series A through I, and the remaining two rows can contain the remaining series Q through Z and J through P. As shown in FIG. 3, the top row can include A, B, C, D, E, F, G, H, I, J letter keys (A-J keys). The second row can include K, L, M, N, O, P, Q, R, S letter keys (K-S). The third row can then include T, U, V, W, X, Y, Z letter keys (T-Z keys). According to specific situations, some of the keys on the rows can be adjusted as needed. The keys can similarly be arranged from left-to-right order in the rows with the rows in bottom-to-top order, as shown in FIG. 4.

The present invention thus provides an orderly and logical arrangement of keys corresponding to the sequential order of letters of the alphabet. The present invention may be especially useful for users whose native language is not English. For these users, keystroke entry speed can be increased because the user need not attempt to memorize a seemingly arbitrary arrangement of keys in addition to translating the information to be entered into the English language. Even users whose native language is English can benefit from the present invention, in that memorization of the location of the keys is much simpler.

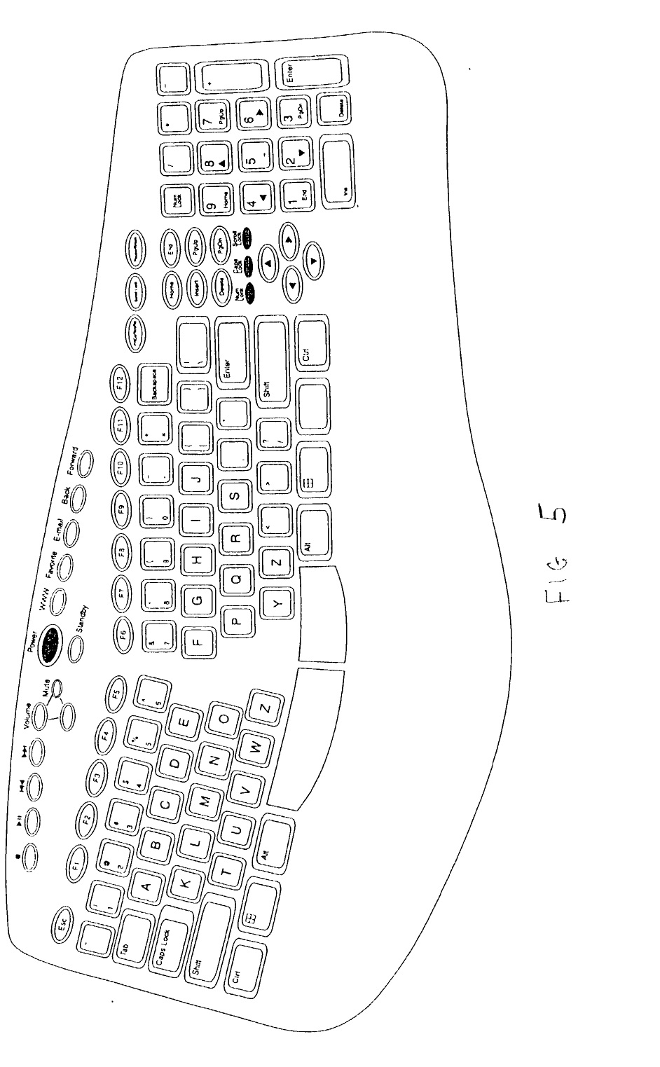

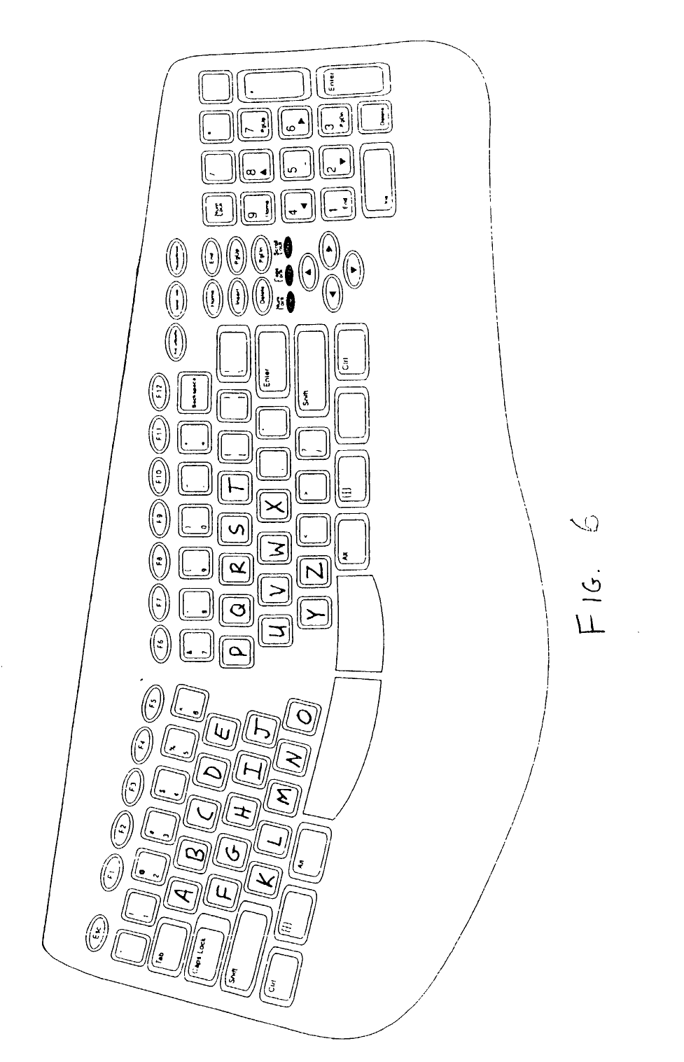

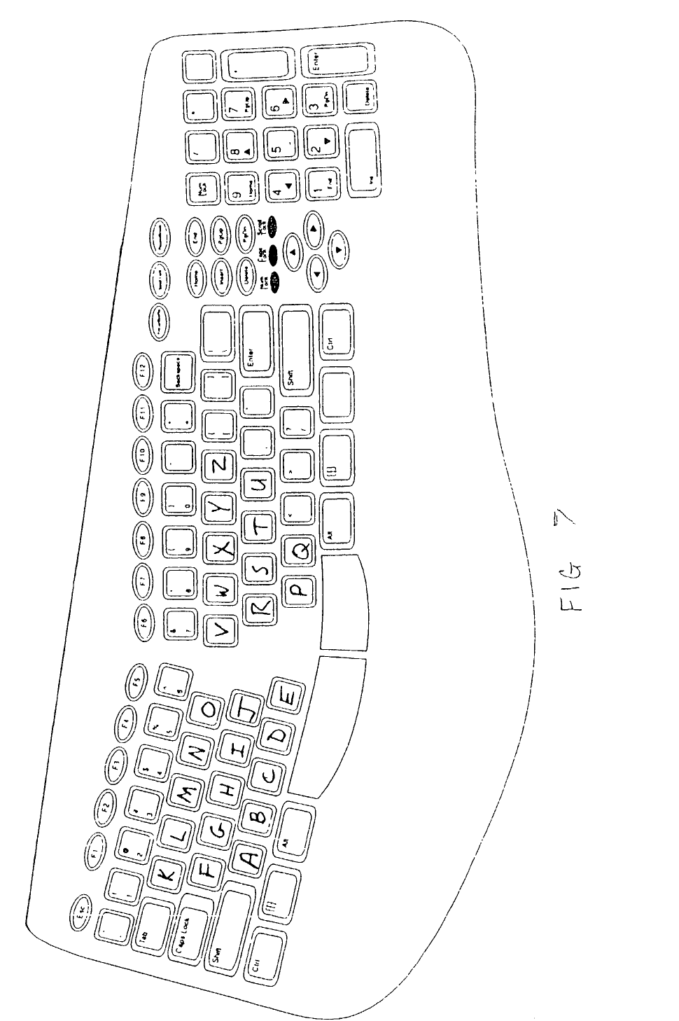

The present invention can be used with an ergonomically configured keyboard with hot function keys, as illustrated in FIGS. 5 through 7, where two spatially distinct sets of letters are separated by a “split” in the keys. In FIG. 5, the keys are arranged in sequential order from left-to-right across the rows, and the rows are arranged in sequential order from top-to-bottom. Right and left sides can each include a series of keys arranged from left-to-right across each row of each side, then from top-to-bottom order in each side, as shown in FIG. 6. The embodiment of FIG. 6 includes left and right sides where the left side includes the letters A through O, and the right side includes P through Z. Of course, the “split,” or open section in the keys could be adjusted, such that each side would contain a series of keys different than those shown in the figures. FIG. 7 shows the keys arranged in a manner similar to those in FIG. 6, only arranged from left-to-right and bottom-to-top in each side.

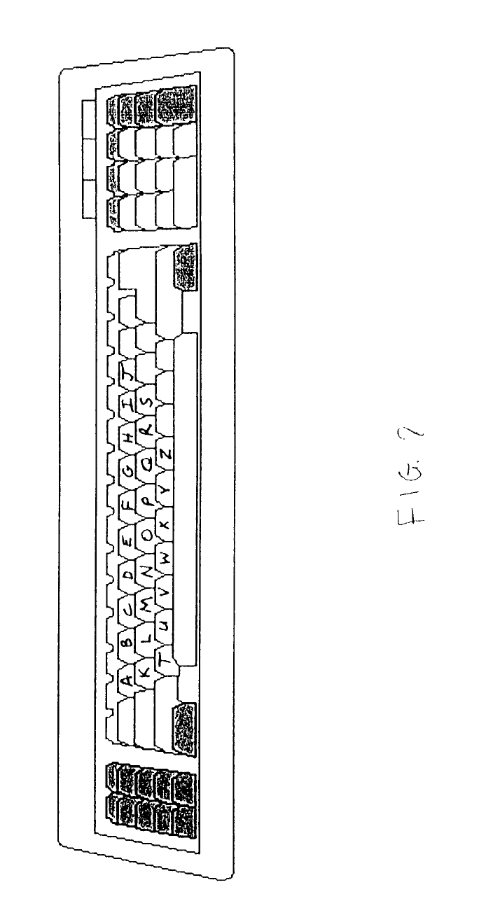

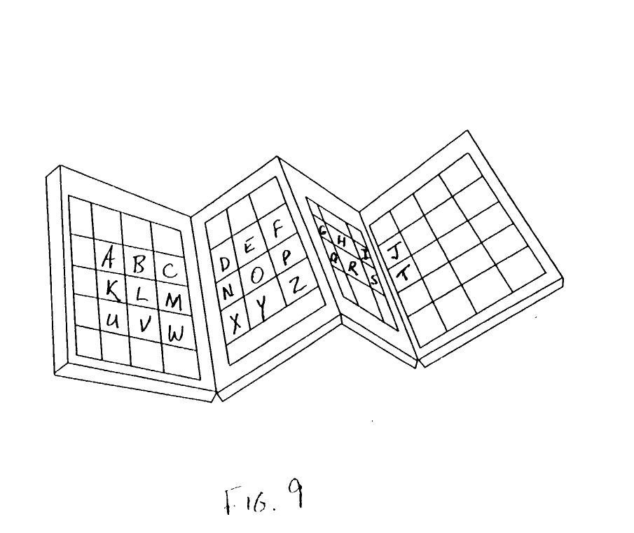

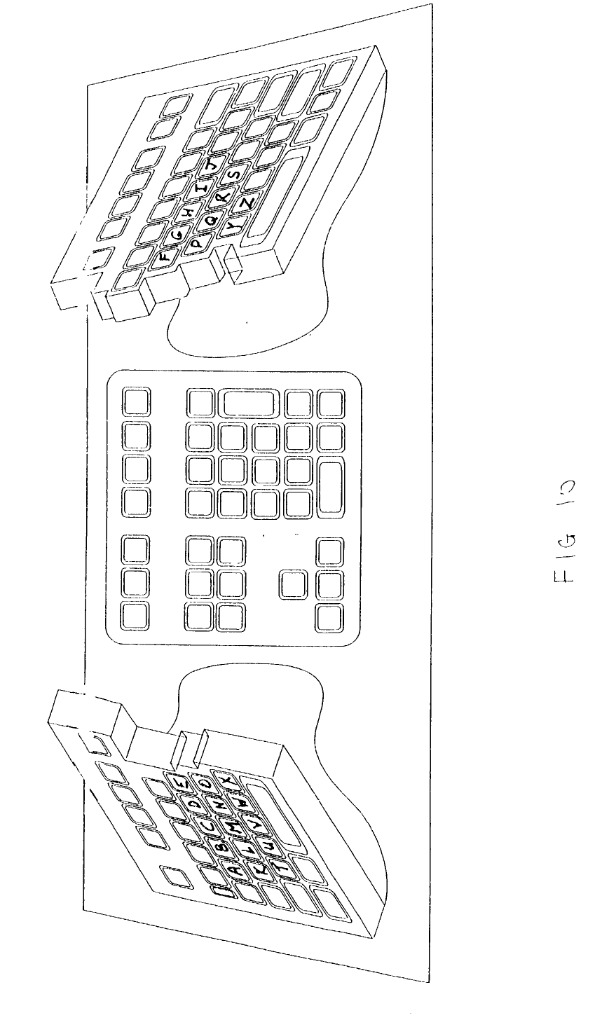

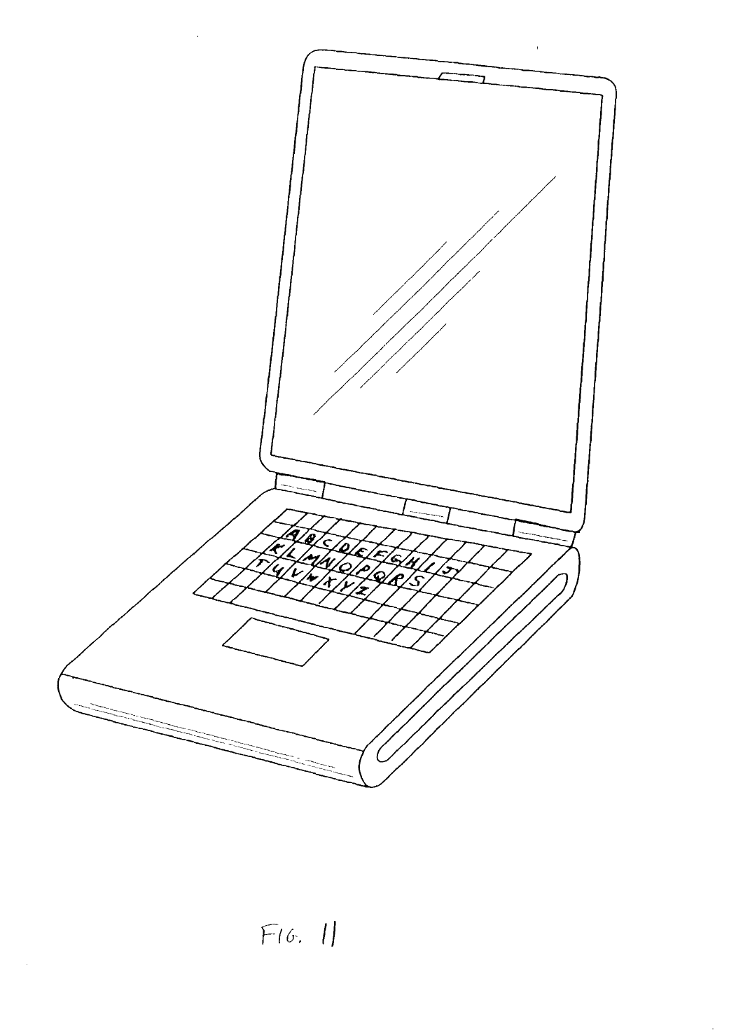

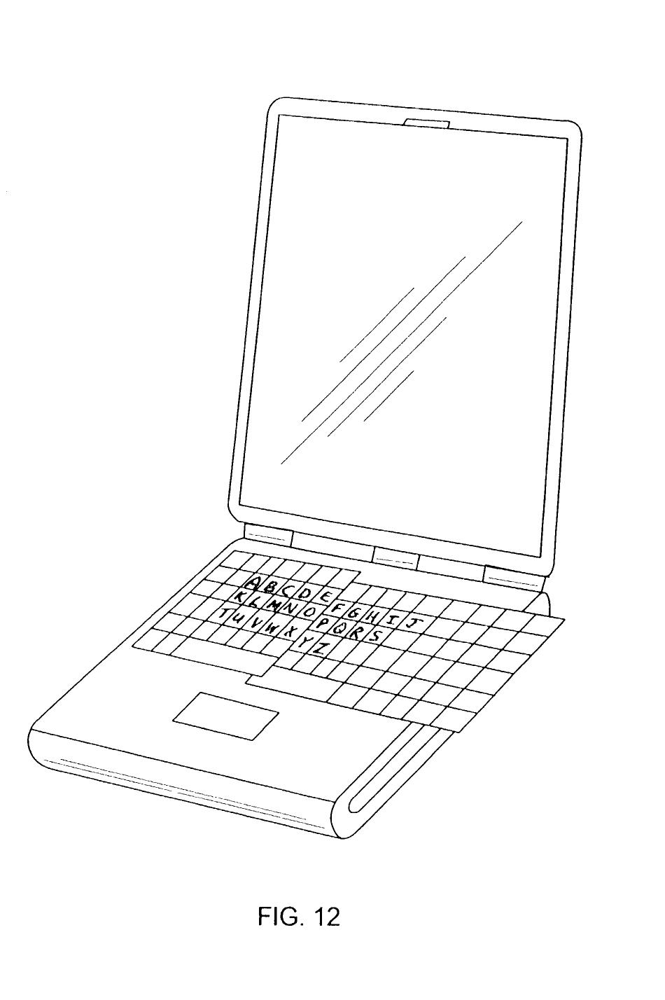

The present invention can also be used as a component of an industrial control system (not shown) and could appear as shown in FIG. 8. Such a control system could be used, for instance, on manufacturing or packaging equipment. The invention can also be configured as a foldable keyboard, as shown in FIG. 9, which can be folded for easy and compact storage, and expanded for use. FIG. 10 illustrates the present invention as used on a separable keyboard, where each side can be used by a different hand and the sides can be spatially distanced from each other for ease of use. The keyboard can also be used as a keyboard device for a computing device. As shown in FIG. 11, the computing device can be a portable computer. The keyboard can also be made to be expandable by sliding, as shown in FIG. 12. A slidably expandable configuration can be used to provide a keyboard that collapses for storage in a small space and yet expands for ease of use.

Like the keyboard currently in use, the present invention can also include number keys, sign keys, function keys, specialized keys and knobs, etc., as shown in FIG. 3. The enhanced design will greatly benefit the people who presently use computers all over the world in every field and also in many families.

According to another embodiment of the invention, the keyboard can be split into several sections, which can be used separately, similar to the embodiment illustrated in FIG. 10. The keyboard can be molded into an ergonomic type of keyboard design, as shown in FIGS. 5 through 7. This can make it easier for two hands to operate.

The present invention, also referred to as the F-Alphabetical keyboard system assembly, is a logical and orderly arrangement of keys on a keyboard. A single printed circuit board can contain an F-Alphabetical matrix of keys that are sandwiched between two plastic housings. A single thin cable known as a keyboard connector (not shown) can connect the keyboard assembly to a keyboard controller on a motherboard. When a key is pressed, circuitry in the keyboard generates a key code, which is passed to the PC or other corresponding computing systems. The row and column signals that are generated are interpreted by a keyboard interface converter-IC (typically located on the keyboard assembly itself). The keyboard interface converts the row and column signals into a single-byte code that is called a key code or scan code. By using different individual code(s), the computer circuitry can determine which corresponding letters, figures, data, records, numbers, and commands should be registered.

This circuitry control system is much faster than the original mechanical typewriter. Therefore, by using the F-Alphabetical Keyboard system, a user can type as fast as he or she is capable of and not worry about any key jamming problems. Furthermore, the F-Alphabetical Keyboard system allows keyboard users to type much easier, and to memorize the locations of the key easily, accurately and efficiently.

The arrangement of the keyboard of the present invention is according to the alphabetical chart. This design is established based on using logical, orderly, and systematic systems to aid the brain in coordinating with the hand, fingers and the whole body to easily memorize and act thereupon. Therefore, the present invention is easier for the typist or computer keyboard user to learn, memorize, and use. The present invention also makes a keyboard more convenient to type with and enter data or information. Consequently, the invention provides more accurate and faster results.

The present invention preferably uses the sequentially ordered keys in three or four or more rows. This is because if the sequentially ordered keys are used on just one or two rows, then the keyboard becomes too wide for a user to comfortably use.

Another embodiment of this invention is that of the alphabetical arrangement and the ergonomic type keyboard design combination, with a convex shape, the result being a keyboard that a user can operate with either one or two hands (which can also be very convenient for some single-handed or handicapped users). This is because the user can place his or her hands and arms in a relaxed and comfortable position. Furthermore, because the letters are arranged in sequential order, the user's efficiency for speed in typing can be very high. At the same time the keyboard can reduce stress and fatigue of the arms, hands, and fingers.

In another embodiment, the keyboard is much more convenient for blind, or otherwise handicapped people, because they do not need to memorize the seemingly arbitrary QWERTY arrangement. Handicapped users need only know the first letter of each row and how the keys are ordered, i.e., top-to-bottom or bottom-to-top, and can type without having to watch the keyboard.

The present invention can include an information input keyboard and keypad, which can be used with many kinds of industrial control systems used for typing, data and information input. Also, the present invention can be used with many types of computers. Although the above drawings show the basic utilization of this invention for a keyboard/keypad or input device especially for use with computers and related devices, this invention, idea, design, and basic structure can be applied to any kind of data and information input device or equipment. For example, it can be used with any control device such as keypads, keyboards, TTY keyboards/keypads, laptop keyboard/keypads, palm pilots, and notebook keypads, electronic communication board/pads, telephone board/pads, electronic typewriter board/pads, as well as any control system keyboard/keypad.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A keyboard device, comprising:
an upper row of at least 10 keys, each key corresponding to one of the group of letters A, B, C, D, E, F, G, H, I, and J, the letters arranged on the keyboard in sequential order from a left-to-right direction,
a home row of at least 9 keys, each key corresponding to one of the group of letters K, L, M, N, O, P, Q, R, and S, the letters arranged on the keyboard in sequential order from a left-to-right direction; and
a lower row of at least 7 keys, each key corresponding to one of the group of letters T, U, V, W, X, Y, and Z, the letters arranged on the keyboard in sequential order from a left-to-right direction.

2. A device in accordance with claim 1, wherein the keyboard device comprises a computer keyboard for use with a computing device.

3. A device in accordance with claim 2, wherein the computing device is a portable computer.

4. A device in accordance with claim 1, wherein the keyboard device is a component of an industrial control system.

5. A device in accordance with claim 1, wherein the keyboard device is configured for use by handicapped persons.

6. A device in accordance with claim 1, wherein the keyboard and the keys of the keyboard are arranged in an ergonomic configuration.

7. A device in accordance with claim 1, wherein the keyboard is foldable.

8. A device in accordance with claim 1, wherein the keyboard is slidably expandable.

9. A keyboard device, comprising:
an upper row of at least 10 keys, each key corresponding to one of the group of letters Q, R, S, T, U, V, W, X, Y, and Z, the letters arranged on the keyboard in sequential order from a left-to-right direction,
a home row of at least 9 keys, each key corresponding to one of the group of letters H, I, J, K, L, M, N, O, and P, the letters arranged on the keyboard in sequential order from a left-to-right direction; and
a lower row of at least 7 keys, each key corresponding to one of the group of letters A, B, C, D, E, F, and G, the letters arranged on the keyboard in sequential order from a left-to-right direction.

10. A device in accordance with claim 9, wherein the keyboard device comprises a computer keyboard for use with a computing device.

11. A device in accordance with claim 10, wherein the computing device is a portable computer.

12. A device in accordance with claim 9, wherein the keyboard device is a component of an industrial control system.

13. A device in accordance with claim 9, wherein the keyboard device is configured for use by handicapped persons.

14. A device in accordance with claim 9, wherein the keyboard and the keys of the keyboard are arranged in an ergonomic configuration.

15. A device in accordance with claim 9, wherein the keyboard is foldable.

16. A device in accordance with claim 9, wherein the keyboard is slidably expandable.

17. A keyboard device for use with a computing device, comprising:
a plurality of keys arranged on the keyboard, each key corresponding to a letter in an alphabet; and
at least three rows in which the keys are arranged on the keyboard, each row including a set of letters arranged in the row in a sequential order;
wherein sequential arrangement of the keys on the keyboard assists a user of the keyboard in recalling a location of any particular key corresponding to a particular letter of the alphabet, to better enable the user to quickly enter keystroke commands to the computing device.

18. A device in accordance with claim 17, wherein the keys of each row are arranged in the row in a sequential order from a left-to-right direction, relative to the user's position, and wherein the rows are arranged on the keyboard such that a leftmost key of any row is sequentially greater than a leftmost key of any row below it, relative to the user's position.

19. A device in accordance with claim 17, wherein the keys of each row are arranged in the row in a sequential order from a left-to-right direction, relative to the user's position, and wherein the rows are arranged on the keyboard such that a leftmost key of any row is sequentially less than a leftmost key of any row below it, relative to the user's position.

20. A device in accordance with claim 17, wherein the keyboard and the keys of the keyboard are arranged in an ergonomic configuration.

21. A device in accordance with claim 17, wherein the keyboard is foldable.

22. A computer keyboard device for use with a computing device, comprising:
a plurality of keys arranged on the keyboard, each key corresponding to a letter in an alphabet;
the keys are arranged on the keyboard in at least three rows, each row including a set of letters arranged in the row in a sequential order;
the rows each including two spatially distinct sets of letters, the spatially distinct sets spaced to provide an ergonomic benefit to a user of the keyboard; and
wherein the sequential arrangement of the keys on the keyboard assists the user of the keyboard in recalling a location of any particular key corresponding to a letter of the alphabet, to better enable the user to quickly enter keystroke commands to the computing device.

23. A device in accordance with claim 22, wherein the spatially distinct set of letters of the rows are arranged into two halves of the keyboard, a left half and a right half, relative to the user's position:
the left half including keys corresponding to letters of the alphabet A through O; and
the right half including keys corresponding to letters of the alphabet P through Z.

24. A device in accordance with claim 22, wherein the keys of each half of each row are arranged in the half of the row in a sequential order from a left to a right direction, relative to the user's position, and wherein the rows are arranged such that a leftmost key of any half of any row is sequentially greater than a leftmost key of any half of any row below it, relative to the user's position.

25. A device in accordance with claim 22, wherein the keys of each half of each row are arranged in the half of the row in a sequential order from a left-to-right direction, relative to the user's position, and wherein the rows are arranged such that a leftmost key of any half of any row is sequentially less than a leftmost key of any half of any row below it, relative to the user's position.

26. A device in accordance with claim 22, wherein the keyboard is foldable.
